(19) United States
(12) Patent Application Publication
(10) Pub. No.: US 2011/0265150 A1
(43) Pub. Date: Oct. 27, 2011

(54) MEDIA ASSET/CONTENT SECURITY CONTROL AND MANAGEMENT SYSTEM

(75) Inventors: Elaine M. Spooner, Winnetka, CA (US); John D. Koscheka, Los Angeles, CA (US); Michael S. Bessolo, Glendale, CA (US); Mark L. Simpson, Monterey Park, CA (US); Jean L. Yuan, Manhattan Beach, CA (US); J. Craig D. Russell, Playa Vista, CA (US); Christopher M. Bettes, Los Angeles, CA (US); Greg McCarthy, Santa Monica, CA (US); Srinivas Kundula, Portola Hills, CA (US); Venkata Nagaraju Mantena, Irvine, CA (US)

(73) Assignee: FOX ENTERTAINMENT GROUP, INC., Los Angeles, CA (US)

(21) Appl. No.: 13/091,005

(22) Filed: Apr. 20, 2011

Related U.S. Application Data
(60) Provisional application No. 61/326,549, filed on Apr. 21, 2010.

(51) Int. Cl. H04N 7/16; H04L 29/06

(52) U.S. Cl. 726/4; 726/6; 726/2

(57) ABSTRACT

A system, method, apparatus, and computer readable storage medium provide the ability to deliver media content in a secure manner in a computer system. A storage repository stores media content and marketing assets for the media content. A server computer is coupled to the storage repository and enabled to provide access to the media content and marketing assets via a website accessible on the Internet worldwide to a user. A digital advertising publicity repository (DAPR) enables an administrator to define first access rights for the user to access the website and second access rights for the user to access the DAPR.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Provisional Patent Application Ser. No. 61/326,549 filed on Apr. 21, 2010, entitled “MEDIA ASSET/CONTENT SECURITY CONTROL AND MANAGEMENT SYSTEM”, by ELAINE M. SPOONER, JOHN D. KOSCHEKA, MICHAEL S. BESSOLO, MARK L. SIMPSON, JEAN L. YUAN, J. CRAIG D. RUSSELL, CHRISTOPHER M. BETTES, GREG MCCARTHY, SRINIVAS KUNDULA, and VENKATA NAGARAJU MANTENA, Attorney Docket No. 241.14-US-P1.

This application is related to the following co-pending and commonly-assigned patent application, which applications are incorporated by reference herein:

U.S. patent application Ser. No. ______, filed on the same date herewith, entitled “DIGITAL DELIVERY SYSTEM AND USER INTERFACE FOR ENABLING THE DIGITAL DELIVERY OF MEDIA CONTENT” by ELAINE M. SPOONER, JOHN D. KOSCHEKA, MICHAEL S. BESSOLO, MARK L. SIMPSON, JEAN L. YUAN, J. CRAIG D. RUSSELL, CHRISTOPHER M. BETTES, GREG MCCARTHY, SRINIVAS KUNDULA, and VENKATA NAGARAJU MANTENA, Attorney Docket No. 241.12-US-U1, which application claims priority to U.S. Provisional Patent Application Ser. No. 61/326,538, filed on Apr. 21, 2010, entitled “DIGITAL DELIVERY SYSTEM AND USER INTERFACE FOR ENABLING THE DIGITAL DELIVERY OF MEDIA CONTENT” by ELAINE M. SPOONER, JOHN D. KOSCHEKA, MICHAEL S. BESSOLO, MARK L. SIMPSON, JEAN L. YUAN, J. CRAIG D. RUSSELL, CHRISTOPHER M. BETTES, GREG MCCARTHY, SRINIVAS KUNDULA, and VENKATA NAGARAJU MANTENA, attorneys' docket number 241.12-US-P1; and

U.S. patent application Ser. No. ______, filed on the same date herewith, entitled “CUSTOMIZED BILLBOARD WEBSITE ADVERTISEMENTS”, by ELAINE M. SPOONER, JOHN D. KOSCHEKA, MICHAEL S. BESSOLO, MARK L. SIMPSON, JEAN L. YUAN, J. CRAIG D. RUSSELL, CHRISTOPHER M. BETTES, and GREG MCCARTHY, Attorney Docket No. 241.13-US-U1, which application claims priority to U.S. Provisional Patent Application Ser. No. 61/326,544 filed on Apr. 21, 2010, entitled “CUSTOMIZED BILLBOARD WEBSITE ADVERTISEMENTS”, by ELAINE M. SPOONER, JOHN D. KOSCHEKA, MICHAEL S. BESSOLO, MARK L. SIMPSON, JEAN L. YUAN, J. CRAIG D. RUSSELL, CHRISTOPHER M. BETTES, and GREG MCCARTHY, Attorney Docket No. 241.13-US-P1.

### BACKGROUND OF THE INVENTION

1. Field of the Invention

The present invention relates generally to the delivery of media content, and in particular, to a method, apparatus, system, article of manufacture, and computer readable storage medium for maintaining the security of assets/content in a digital file-based network distribution system.

2. Description of the Related Art

Many types and pieces of information or media content may be utilized as part of the broadcast, advertisement, and sale of such content. Content from various studios (e.g., FOX™) may include:
Over 2,500 Feature Films; over 14,000 Television Series, Seasons and Episodes; and over 1,000 Specials, Movies of the Week and Mini Series;
Over 100,000 images: Production Stills, Logos, Artwork, Gallery and Episodic Photos;
Over 12,000 Scripts and over 10,000 Music Cue Sheets;
Over 7,300 trailers and other promotional videos;
Over 2,500 episodes for screening;
Over 9,300 broadcast quality files, representing over 700 episodes; and
Over 1,000 broadcast quality promotional videos (Television spots, etc.).

Today's physical media-based distribution model is inefficient and subject to challenges including import-export delays, courier, flight or customs problems. In addition, the reliance on fuel-based logistics during product shipping is counter to television distribution and its licensees' carbon neutral operational goals. Finally, physical media-based distribution is expensive with dependencies on manufacturing, shipping and physical media management. For a better understanding of these problems, a description of prior art media distribution models is useful.

Prior art techniques used to fulfill its customer's requests for advertising and publicity materials required the physical distribution of such materials on physical paper—e.g., slides and transparencies, ad-slicks (camera-ready advertisements of varying sizes that are used in print media such as newspapers and magazines), scripts and music cue sheets. Slides would be duplicated at a photo lab and scripts would be photocopied. The materials would then be boxed up and shipped out to customers such as international broadcasters. These boxes would often get held up at customs, or the materials would be misplaced by the customer—adding to the expense of both time and money.

To overcome some of the prior art problems, digital processes have been reshaping all aspects of the broadcast television industry. Product is now regularly digitally recorded, edited and distributed to audiences via server-based play out. This evolution may naturally extend to the content supply chain and distributor relationships whereby physical media and shipping will soon become obsolete means for content delivery. In this regard, websites have been developed where customers are able to download advertising and publicity materials needed whenever (and as often) as necessary. Instead of slides, customers can download JPGs; instead of paper scripts, downloadable PDFs are available. Written information like synopses, cast and crew biographies, awards, and press quotes are also available on such websites (e.g., FOXFAST™).

Security mechanisms may also exist on such prior art websites. Such security mechanisms include password-protection that is tied into a studio's television distribution sales system so customers are only given access to materials for the television series and films that the customer currently licenses from the particular studio. However, such a limited system does not allow the customer to view all of the assets available for the customer to license. In this regard, a television distribution sales group is continuously selling titles from a studio's entire catalog, and since customers can only see titles they have already licensed in prior art websites, the need for an overall comprehensive catalog site is desirable. Further, prior art security mechanisms fail to provide the flexibility for controlling access and provide limited security mechanisms and capabilities to prevent unauthorized use and access.

To overcome the inability to view all assets available, the prior art further developed a non-password protected catalog website to showcase all titles (e.g., features, television series, specials, movies of the week, mini series, etc.) available from a particular entity. Such a prior art website provides the ability to search assets using a variety of criteria including actor, award, box office, genre, and synopsis key words (e.g. all titles about ‘baseball’).

In addition to the above websites, a further prior art website allows customers to screen television shows and movies without waiting for a digital video disc (DVD) (and saving the costs of burning and shipping such disc as well). Such screening is viewed as a desirable pre-sales tool. Digital rights management (DRM) may be used in such prior art websites to protect the content from unauthorized viewing and piracy.

However, for a media content owner to efficiently and easily deliver pre-sales and sold content to a customer while allowing a customer to easily and efficiently browse all content and receive such content is not provided by the above-described prior art systems. Instead, customers are forced to utilize multiple websites for different purposes and media content owners do not have the flexibility to easily manage, sample, and deliver such content to both prospective and actual customers. In addition, prior art systems fail to provide the ability to digitally deliver broadcast quality digital files. Instead, the prior art requires the duplication of a tape and the shipping of the tape overseas. Further, the prior art fails to provide sufficient security measures to prevent unauthorized use.

Thus, the prior art has many problems and deficiencies including:
massive distribution costs to create and ship tapes;
recurring and substantial sunk costs caused by the cost to manage physical media;
product that can leak to the internet prior to a local market telecast;
content leaks that can impact the perceived value of a product;
accelerated demand to ship, schedule, and broadcast programs internationally on the heels of U.S. broadcasts;
greater attention to physically manage higher content volumes against increasingly intense deadlines based on the accelerated demand to air products; and
inadequate security measures to prevent unauthorized access to products.

Accordingly, what is needed is an online digital delivery system that maintains asset/content security.

### SUMMARY OF THE INVENTION

One or more embodiments of the invention provide a website that provides the capability to securely manage digital distribution of all marketing assets, low-resolution screeners, and broadcast quality video. Such embodiments provide a one-stop-shop, online portal designed to conveniently deliver, using house-file video standards, all assets a licensee may need to make purchase decisions, promote, market, and distribute a media content owner's product. Embodiments of the invention may include one or more of the following features:
single login access to combined services for authorized broadcast licensees;
delivery of non-video marketing assets in multiple formats;
screening of all DRM protected video in international markets;
digital delivery of broadcast quality masters to broadcast licensees;
cross platform screening availability of DRM protected video; and
narrow cast branding and marketing messaging.

Advantages/benefits of the invention may include:
elimination of the distribution of physical media-based video elements;
savings on tape manufacturing costs, protection against rising costs associated with high-definition video distribution, and passing of the savings to customers by eliminating all tape servicing costs;
securing of content using state-of-the-art encryption and digital rights management tools; and
accelerated access to licensed products via online 24/7 on-demand delivery.

### BRIEF DESCRIPTION OF THE DRAWINGS

Referring now to the drawings in which like reference numbers represent corresponding parts throughout:

FIG. 1 schematically illustrates a hardware and software environment in accordance with one or more embodiments of the invention;

FIG. 2 illustrates an integrated digital distribution system suite that enables such management and distribution in accordance with one or more embodiments of the invention;

FIG. 3 is a graphical user interface illustrating the ability to establish access privileges for a customer/group in accordance with one or more embodiments of the invention;

FIG. 4 is a graphical user interface used to define and assign rights to a user that has access to multiple systems in accordance with one or more embodiments of the invention;

FIG. 5 illustrates a graphical user interface that provides menu access for uploading assets (audio, video, images, etc.) that the user in FIG. 4 is authorized to perform in accordance with one or more embodiments of the invention;

FIG. 6 is a graphical user interface illustrating an example of images that have been uploaded for the media content “Modern Family” in accordance with one or more embodiments of the invention;

FIG. 7 is a graphical user interface used to define video rights/security access for groups/users in accordance with one or more embodiments of the invention;

FIG. 8 is a graphical user interface illustrating a license rights option selected from an access management menu in accordance with one or more embodiments of the invention;

FIG. 9 illustrates a graphical user interface used to assign broadcast quality rights for a season, series, or episode in accordance with one or more embodiments of the invention;

FIGS. 10 and 11 are tables illustrating a summary and comparison of the content protection used in the prior art (FIG. 10) and in accordance with embodiments of the invention (FIG. 11); and

FIG. 12 is a flow chart illustrating the logical flow for delivering media content in a secure manner in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

A digital delivery system is described in the co-pending applications cross referenced above. Embodiments of the present invention provide enhanced security measures/mechanisms that enable an administrator to efficiently and easily establish a security protocol for users while providing advanced security for media content, marketing and non-marketing assets to be delivered to such users.

To provide such capabilities, embodiments of the invention provide for a system, website/application and user interface that enables a user to view a product catalog and marketing assets, while also providing the ability to screen non-broadcast quality and download broadcast quality media content. The website/application is an integral part of a suite of fully-integrated systems designed to securely manage the worldwide digital distribution of low resolution screeners and high resolution broadcast quality video for business to business (B2B) partners. The digital delivery pipeline provides a one-stop-shop, online portal that conveniently delivers all assets a licensee may need to make purchase decisions, promote, market, and distribute the product of a media content owner. Such media content includes, but is not limited to, free, pay, pay-per-view (PPV), video-on-demand (VOD), and electronic-sell-through (EST) customers.

Embodiments of the invention may eliminate the distribution of all DVD screeners and broadcast video elements, reduce annual tape manufacturing costs, protect against rising costs associated with hi-definition video distribution, and share savings with customers, secure content using state-of-the-art encryption and digital rights management tools, and speed access to licensed product via online 24/7 on-demand delivery.

### Key Definitions

The following terms are used throughout this application document. When used herein, the terms are defined as follows:

Broadcast Video—includes any video delivered to a licensee that is ultimately intended for broadcast or distribution to viewers or consumers of a specific program service. Broadcast Video includes, but is not limited to, promotional content, electronic press kits and full-length licensed content (i.e., features, television episodes, specials, etc.).

“Current” Product—for television programming, “Current” Product is defined as any episodic network television series made available within twenty-four (24) months of its original U.S. telecast. For feature releases, “Current” Product is defined as any feature film which is in its first or second run for any specific media.

Library Product—any Product that is not Current Product.

Preview Video—includes any video not intended for distribution to or viewing by consumers (excluding certain promotional content that may be tagged for web-use). Preview Video is generally used for making product acquisition or scheduling decisions, press distribution, language localization and other pre-broadcast planning purposes.

Quick Delivery (QD) is a television distribution descriptor for Broadcast Video of television product that is mastered with full-mix English stereo audio only. QD elements do not include separate music and effects tracks or textless video backgrounds.

Final International Master (FIM) is a descriptor for Broadcast Video of television product that is mastered with full-mix English stereo audio, stereo music and effects tracks and textless video backgrounds. FIM elements provide the necessary components to create final dubbed language versions for a program.

### Standardized Delivery Formats

Both preview and broadcast video may be provided in various standardized formats in accordance with embodiments of the invention.

Preview Video may be made available as streaming WINDOWS MEDIA VIDEO™ MPEG-2 files encoded at 750 Kbps with a 640×480 screen resolution. Preview Video streaming may require a PC or Mac computer with Internet connectivity. Users may have the option to select true streaming or HTTP (hypertext transfer protocol) progressive download for slower connections.

Broadcast Video files may be available in Standard-Definition (SD) and High-Definition formats (HD). Access to HD video may only be authorized if HD rights are contractually permitted (see detailed description below).

Standard-Definition Broadcast Video may be encoded as SMPTE 356 M D10 (aka IMX) 4:2:2 I-Frame only MPEG-2 at 50 Mbps available in both 25 and 30 fps. Standard-Definition files support up to 8 channels of AES3 audio wrapped in an MXF container. SD video content is provided in both the 525 and 625 video formats.

High-Definition Broadcast Video may be encoded as XDCAM HD 422 (1920×1080 MXF) CBR 50 Mbps Long GoP 4:2:2 Profile and High Level files including up to 8 channels of AES3 audio. Frame rates include 59.94i or 50i.

Standard and High-Definition video for current season television product may be available in 4×3 and 16×9 aspect ratios. For current features and library product, video may be provided in other aspect ratios as available. Standard distribution video formats may include bars, tones and textless main and end title segments.

Broadcast Video files with like frame-rates (i.e., 25 fps) are frame accurate. MXF wrappers currently provide only re-embedded time-code that can also be found in a Broadcast Video files' video stream.

The following table summarizes the broadcast video files that may be supported in accordance with embodiments of the invention. However, while not specifically set forth below, additional files may also be supported. Further, for detailed descriptions of the terms used herein, please see the detailed description below.

| | | | Aspect | Frame | |
|---|---|---|---|---|---|
| Standard | Format | Bit Rate | Ratio | Rate | Audio |
| HD | XDCAM HD 422 | 50 mbps | 16 × 9 | 25 fps | FIM with m&e/ |
| | | | | | QD without m&e |
| HD | XDCAM HD 422 | 50 mbps | 16 × 9 | 30 fps | FIM with m&e/ |
| | | | | | QD without m&e |
| SD | MPEG-2 IMX | 50 mbps | 16 × 9 | 25 fps | FIM with m&e/ |
| | | | | | QD without m&e |
| SD | MPEG-2 IMX | 50 mbps | 4 × 3 | 25 fps | FIM with m&e/ |
| | | | | | QD without m&e |
| SD | MPEG-2 IMX | 50 mbps | 4 × 3 | 30 fps | FIM with m&e/ |
| | | | | | QD without m&e |

Digital delivery of additional broadcast audio files may be supported using the .wav format. 5.1 full mix English audio, 5.1 music and effects (see above m&e) and laugh tracks are additional broadcast audio files that may be supplied (as available). Each channel for such audio content is delivered as discrete .wav audio files. Additional formats, including alternative aspect ratios, may also be available.

### Hardware Environment

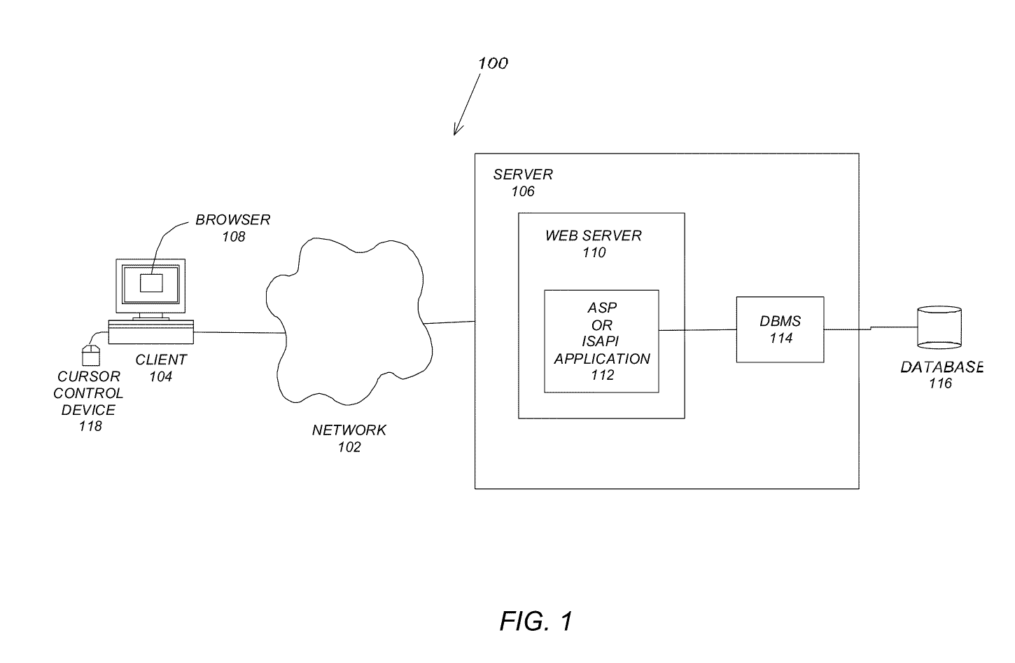

FIG. 1 schematically illustrates a hardware and software environment in accordance with one or more embodiments of the invention, and more particularly, illustrates a typical distributed computer system 100 using a network 102 to connect client computers 104 to server computers 106. A typical combination of resources may include a network 102 comprising the Internet, LANs (local area networks), WANs (wide area networks), SNA (systems network architecture) networks, or the like, clients 104 that are personal computers or workstations, and servers 106 that are personal computers, workstations, minicomputers, or mainframes. Additionally, both client 104 and server 106 may receive input (e.g., cursor location input) and display a cursor in response to an input device such as cursor control device 118.

A network 102 such as the Internet connects clients 104 to server computers 106. Network 102 may utilize ethernet, coaxial cable, wireless communications, radio frequency (RF), etc. to connect and provide the communication between clients 104 and servers 106. Clients 104 may execute a client application or web browser 108 and communicate with server computers 106 executing web servers 110. Such a web browser 108 is typically a program such as MICROSOFT INTERNET EXPLORER™, MOZILLA FIREFOX™, OPERA™, or APPLE SAFARI™. Further, the software executing on clients 104 may be downloaded from server computer 106 to client computers 104 and installed as a plug in or ACTIVEX™ control of a web browser. Accordingly, clients 104 may utilize ACTIVEX™ components/component object model (COM) or distributed COM (DCOM) components to provide a user interface on a display of client 104. The web server 110 is typically a program such as MICROSOFT'S INTERNET INFORMATION SERVER™.

Web server 110 may host an Active Server Page (ASP) or Internet Server Application Programming Interface (ISAPI) application 112, which may be executing scripts. The scripts invoke objects that execute business logic (referred to as business objects). The business objects then manipulate data in database 116 through a database management system (DBMS) 114. Alternatively, database 116 may be part of or connected directly to client 104 instead of communicating/obtaining the information from database 116 across network 102. When a developer encapsulates the business functionality into objects, the system may be referred to as a component object model (COM) system. Accordingly, the scripts executing on web server 110 (and/or application 112) invoke COM objects that implement the business logic. Further, server 106 may utilize MICROSOFT'S™ Transaction Server (MTS) to access required data stored in database 116 via an interface such as ADO (Active Data Objects), OLE DB (Object Linking and Embedding DataBase), or ODBC (Open DataBase Connectivity).

Generally, these components 108-118 all comprise logic and/or data that is embodied in or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

In one embodiment, instructions implementing the browser 108 or other applications for either client 104 or server 106 are tangibly embodied in a computer-readable medium, e.g., data storage device, which could include one or more fixed or removable data storage devices, such as a zip drive, floppy disc drive, hard drive, CD-ROM drive, tape drive, etc. Further, such applications are comprised of computer program instructions which, when accessed, read and executed by the client 104 or server 106 causes such computers 104-106 to perform the steps necessary to implement and/or use the present invention or to load the program of instructions into a memory, thus creating a special purpose data structure causing the computer to operate as a specially programmed computer executing the method steps described herein. Such applications may also be tangibly embodied in memory and/or data communications devices, thereby making a computer program product or article of manufacture according to the invention. As such, the terms “article of manufacture,” “program storage device” and “computer program product” as used herein are intended to encompass a computer program accessible from any computer readable device or media.

Although the term “user computer”, “client computer”, and/or “server computer” is referred to herein, it is understood that such computers 104-106 may include portable devices such as cell phones, notebook computers, pocket computers, or any other device with suitable processing, communication, and input/output capability.

Of course, those skilled in the art will recognize that any combination of the above components, or any number of different components, peripherals, and other devices, may be used with computers 104-106.

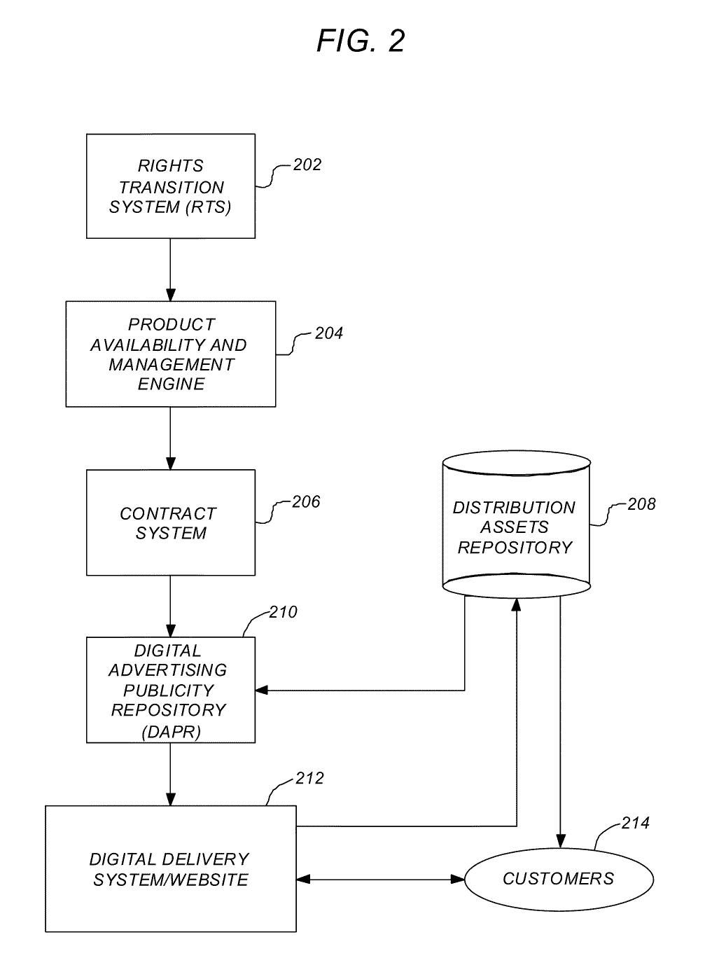

Using the network architecture of FIG. 1, embodiments of the invention may further integrate multiple different systems to provide for the secure management of the digital distribution of media content. FIG. 2 illustrates an integrated digital distribution system suite that enables such management and distribution. Each of the systems and components of FIG. 2 may be implemented by either a client computer 104 or server computer 106 to provide the features described herein.

A custom built repository, referred to as a rights transition system (RTS) 202) manages content and distribution rights. RTS 202 is the foundation of product status feeding downstream systems with information related to distribution rights, media, territory, language, and music rights. In other words, the RTS 202 identifies the ownership rights (i.e., distribution and licensed rights) that are available. Such information includes what one is allowed to do with the product (e.g., if one has any rights to give away/license with respect to a particular product).

The information in RTS 202 may be transmitted or retrieved using a product availability and management engine 204. In other words, product availability and management engine 204 provides the ability to query RTS 202 to retrieve details regarding sales/licensing information. For example, engine 204 may provide information regarding what products are available to sell/license, where the product may be sold/licensed, what media may be sold/licensed, when the product may be sold/licensed, and how long the product may be sold/licensed (e.g., the availability date of every film before 1975 in German). Accordingly, engine 204 may also be known as a recording and reporting engine that provides the ability to query RTS 202 for data to determine available products/content.

Contract system 206 retrieves (or is transmitted) information from product availability and management engine 204. Contract system 206 records details regarding the specific completed transactions/licenses with customers. In other words, the licensed rights such as an identification of a particular product, the time period of the license, and the specific customers part of that license are recorded within contract system 206. For example, all licenses for a television program such as GLEE™ may be recorded within contract system 206. For all such licenses, a user may be given access based thereon. When a new episode of GLEE™ is uploaded, access may be automatically generated based on such recorded licenses (without the need to resubmit or update the license provisions recorded within contract system 206). In addition, any billing to customers for such licensed rights may occur within contract system 206.

The distribution assets repository 208 (also known as ESPRIT™) is a custom built system designed as a studio's repository for distribution assets including full length broadcast video, promotional material, and marketing material. In other words, repository 208 provides a distribution warehouse for product deliverables (i.e., digital downloads for a product). File acceleration software may be used within repository 208 to expedite the delivery of products to customers.

The digital advertising publicity repository (DAPR) 210 is a custom application that feeds (to customers) contractual licensing and product information from upstream sales applications. DAPR 210 is the “air traffic control” mechanism of the digital delivery initiative described herein and allows users/administrators to define/set conditional-based access policies for all file-based distribution assets. Security controls for products/assets may be further established/defined/modified in DAPR 210. In other words, based on the licensed rights from upstream applications 202-208, DAPR 210 provides an administrator with the capability to determine how customers 214 or users can view and select products/content from a digital delivery system/website 212. Information from the upstream applications 202-208 may be pushed into the DAPR system 210 on a regular/semi-regular basis to ensure appropriate security access controls are being utilized. While the different licensed rights information is determined in systems 202-206, the actual downloadable assets are stored in repository 208 (broadcast quality assets) and DAPR 210 (non-broadcast quality assets). DAPR 210 also controls the security mechanisms (i.e., who has appropriate access/download privileges) to determine whether a customer 214 on a delivery system/website 212 can download the assets in repository 208.

Digital delivery system/website 212 is a business-to-business online portal designed to deliver all file-based assets connected to the sales, promotion and broadcast of television distribution licensed properties. In other words, the website 212 is the storefront for the electronic delivery of professional grade product deliverables.

### Digital Delivery System Overview

Through the above described systems and components of FIG. 1 and FIG. 2, a digital delivery system 212 (that may include a website or a network accessible application) provides a secure, encrypted and easy to use file-based delivery solution to receive video assets. The system 212 provides a central access hub for licensees to source all video assets required for content acquisition decisions, promotions, and broadcast. In this regard, preview video streamed through the system 212 can replace DVD screeners while broadcast video accessed via system 212 replaced videotape. The DAPR system 210 is used to define the access available to customers 214 on system/website 212.

In one or more embodiments of the invention, there are two different aspects to providing the digital delivery system 212: (1) persons responsible for managing and uploading the content; and (2) customers 214 that may download the content using system/website 212. The uploading personnel may not be concerned with who receives the content and may only be responsible for uploading the content itself Administrators are used to not only manage the access rights for the uploading personnel, but also for the customers 214 that download the content. Accordingly, the administrators determine who will receive the access rights to both upload and download the media content/assets. Details regarding such security control mechanisms are described below. To better understand such security provisions, a functional description of system/website 212 is useful.

The system 212 provides/combines three different sites/functions into a single system/application: (1) a public site catalog; (2) marketing assets system; and (3) a screening and download system.

The public site catalog provides a non-password protected area for pre-sales information to be searched. All content available can be viewed to assist a customer in evaluating content as part of the purchase decision. As part of catalog, digital posters may be displayed with content information. By hovering over a poster with a cursor, an enlarged view may be displayed, that upon activation, provides an overview of the product/property associated with the poster that may include cast or other publicly available information. Low resolution photographs, public trailers, and other publicly accessible material may be available in this portion of the system 212.

The marketing assets system is available to authorized users via login and password. The information in the marketing assets system provides information based on the particular license associated with the authorized user. In other words, the assets that can be viewed may reflect the licensed rights from contract system 206 based on the security parameters set forth in DAPR 210. Accordingly, when an asset has been licensed, the content owner (e.g., sales representative from the content owner) enters the license terms into the back-end system (e.g., contract system 206), and such assets are reflected in the logged-in area of system 212.

The screening and download system may be viewed by customers 214 once logged in (e.g., via username and password). In this system, the authorized customer 214 can view items available for download and screening. The screening capability allows users 214 to preview video content using a graphically rich user interface as described herein. Further, the screening capabilities may be configured for multi-party viewing, via a television, or through a mobile device. Such screening and downloading capabilities may include assets such as full length video, audio elements, photography, scripts, music cue sheets, on-air promos, etc. In addition to traditional marketing assets, authorized customers 214 may have the ability to retrieve/download intellectual property (including a technical data transfer) associated with an asset/show/concept. Such distribution is referred to as a format title asset distribution. For example, the idea/concept for a reality show (e.g., Beauty and the Geek™) may be sold to a customer 214 in a different country and the screening/download system provides the ability to transfer the concepts, set design, blue prints, etc. for the idea/concept to the authorized customer 214.

In addition, the screening and download area provides a unique user interface, indicating content available for download and screening, for every authorized customer 214 based on what that customer 214 has licensed. Further, such downloadable content may be DRM-protected.

### Media Asset/Content Security

To ensure secure access for all media content and marketing assets, user security settings may be established both for DAPR 210 and for the digital delivery system/website 212. To identify a user, a username and password may be emailed to a user when a user is first granted access to either DAPR 210 or digital delivery system/website 212. To define access privileges for users, the user logs into either DAPR 210 or system 212 using the assigned username and password. A secure hypertext transfer protocol (HTTPS) or other mechanism for maintaining a secure link between the user/client 104 and server 106 is utilized. Once logged in, the user has access privileges based on a profile or settings assigned to/associated with the user. Such access privileges may provide the ability to define access privileges for other users and/or the ability to access media content and/or marketing assets.

Security settings may be established for multiple different groups at multiple different levels including customers, administrators (e.g., employees of a media content owner), and super administrators (e.g., supervisors of employees of media content owner). To assign security privileges to multiple classes of users at a single time, users may be assigned to one or more groups that are assigned security privileges. In this regard, users' security/access privileges are inherited from the group(s) to which the users belong. Accordingly, when changes are made to the security privileges of a particular group, the change in privileges flows through to the group's users.

If a user belongs to multiple groups that have conflicting access privileges, an administrator or super-administrator may determine the priority for security access. The priority can be established on a per-group basis (e.g., privileges of group A supersedes any privileges of group B) or on a per product basis (e.g., all grants/denials of access to a particular asset supersedes any denial/grant of access established in a different group to which the user belongs). Alternatively, a policy may be established to provide the least/most access available for any product granted by any group to which the user belongs.

Two groups that may be established for users are that of DAPR 210 and FOXFAST™ (also known as digital delivery system/website 212). Users associated with the DAPR 210 group are often administrators (e.g., are of user type “Admin User”, will have access to DAPR 210, and inherit the group's access rights and functional options.

Users associated with the FOXFAST™ 212 group, once logged into the system 212 will inherit the group's access rights as well as access rights to various menus and functional options within system 212.

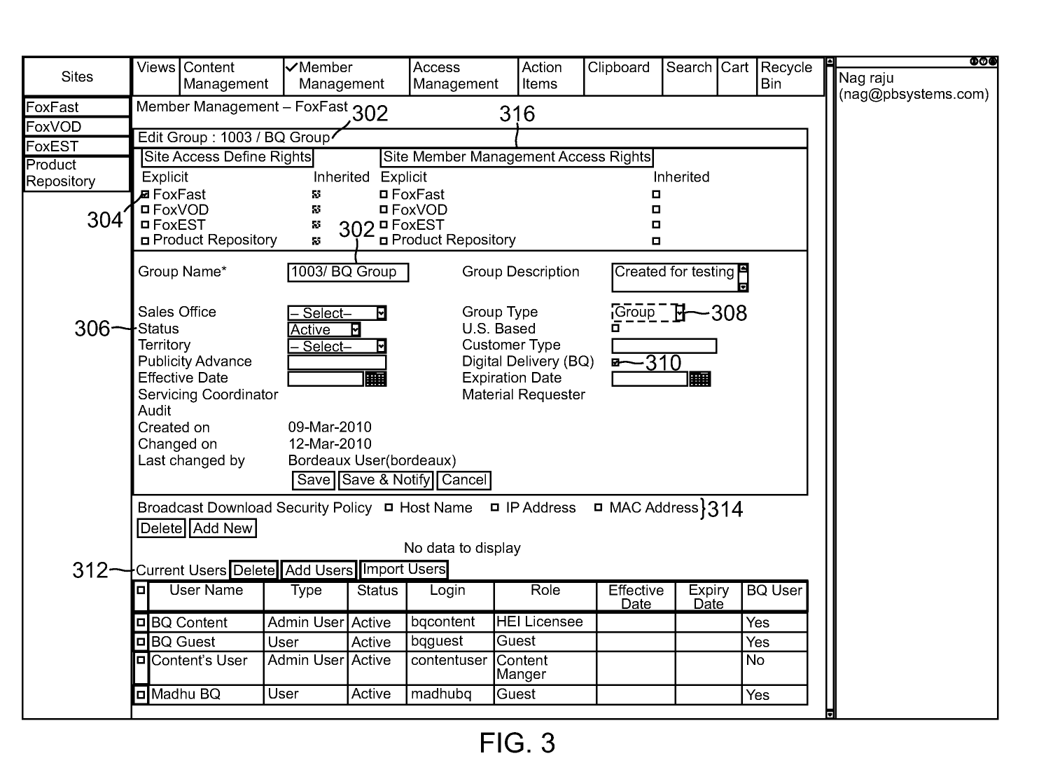

FIG. 3 is a graphical user interface illustrating the ability to establish access privileges for a customer/group in accordance with one or more embodiments of the invention. In FIG. 3, the access privileges for the group 1003/BQ Group 302 are being defined. As illustrated, group 302 has the following security settings: FOXFAST™ 304, Active status 306, Group type 308, and accepts digital delivery (BQ—Broadcast Quality) 310. Users associated with group 302 are listed in the “current users” section 312. A user can belong to more than one customer/group. Further one method for adding a user to a group is by selecting the Add User or Delete tabs in area 312. In FIG. 3, the administrator managing the 1003/BQ Group can explicitly define rights granting access privileges or management access rights for the group to Video-On-Demand (VOD), EST, and/or the product repository (see Site Member Management Access Rights 316). The group can be defined as currently active, and an effective starting date and expiration date for the group (or access rights of the group) can be specified. Further, the administrator can determine whether the group members are authorized to receive the digital delivery (e.g., ability to download) of broadcast quality media assets/content.

Machine level access control restricting broadcast download to specific IP and/or MAC addresses may also be specified using fields 314. In this regard, the download of any title or asset may be restricted to a particular IP (internet protocol) and/or MAC (media access control) address. Such setting 314 in the graphical user interface of FIG. 3 creates a handshake between a specific computer and an employee/user.

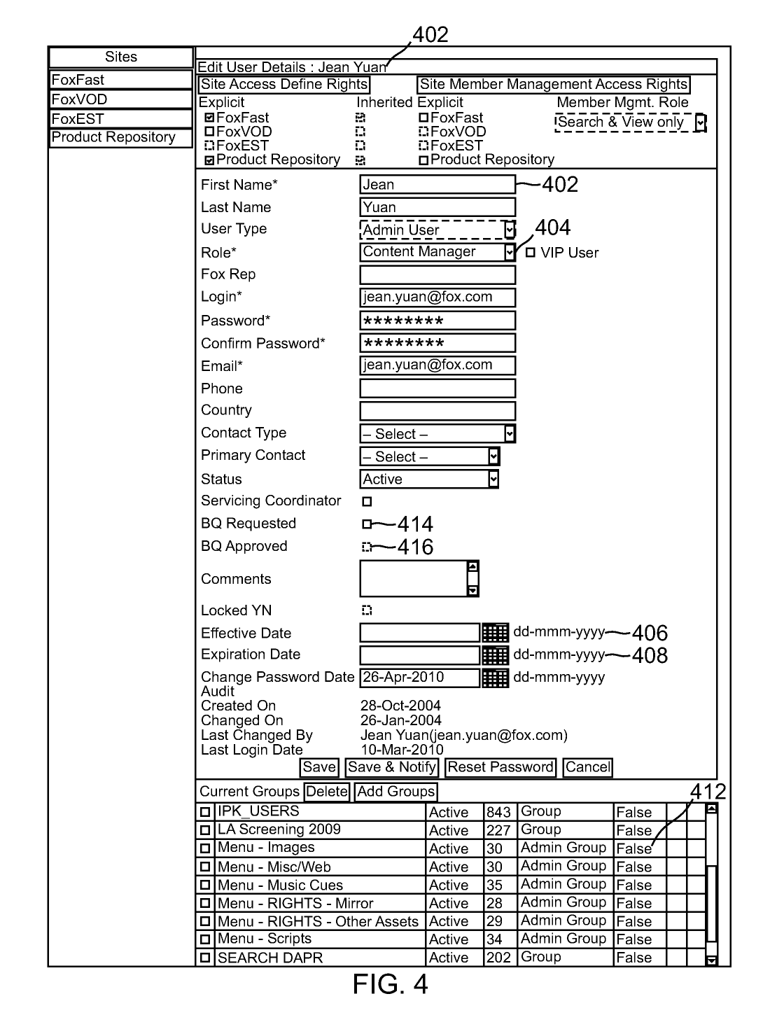

While FIG. 3 represents group settings for a group with FOXFAST™ 212 access, FIG. 4 is a graphical user interface used to define and assign rights to a user that has access to both DAPR 210 and FOXFAST 212 (i.e., the user belongs to both groups). In this regard, the user has user type set to “Admin User.” As indicated, the user's name is Jean Yuan 402 who serves as a content manager 404. Effective 406 and expiration 408 dates for the user may be specified. The current groups listed in area 410 show all groups associated with this user. The user, once logged into DAPR 210, will inherit the groups access rights (various functional options). For example, “Menu-Images” 412 allows this user to upload image assets.

When a customer licenses a particular title, all assets for that title are opened up except for broadcast quality which must be explicitly specified (see settings for download and broadcast quality download settings herein). Accordingly, the broadcast quality authorization is a separate authorization process. A user will have a broadcast quality requested authorization and a broadcast quality approved authorization that must be set by two different users that have broadcast quality validating privileges. Field 414 may be checked off in which case an email address and date of the request will appear adjacent to the field 414 (indicating that broadcast quality authorization has been requested). Similarly, once approved, a checkmark will appear in field 416 with an email address and date information appearing adjacent thereto to indicate the broadcast quality request was approved by the person at the specified email address (on the specified date).

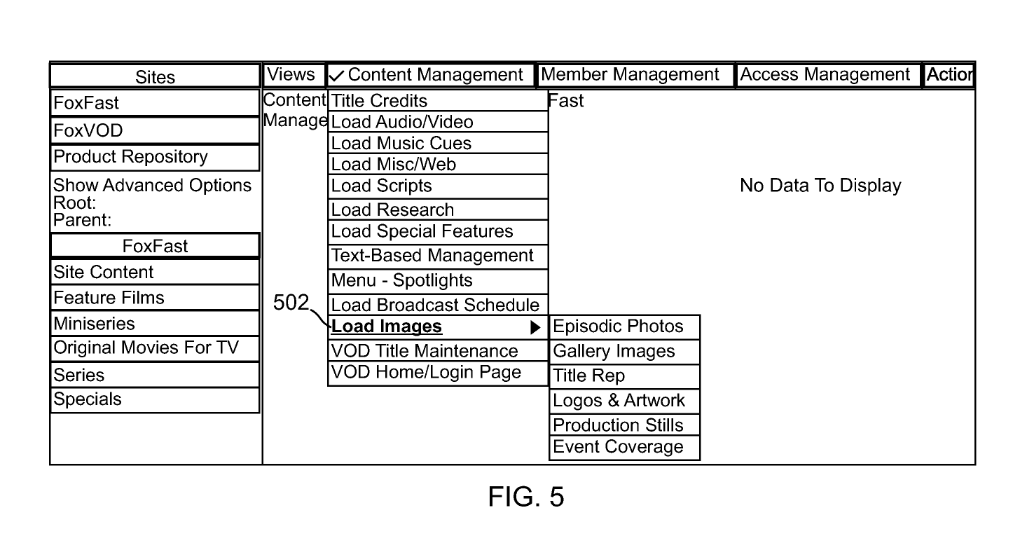

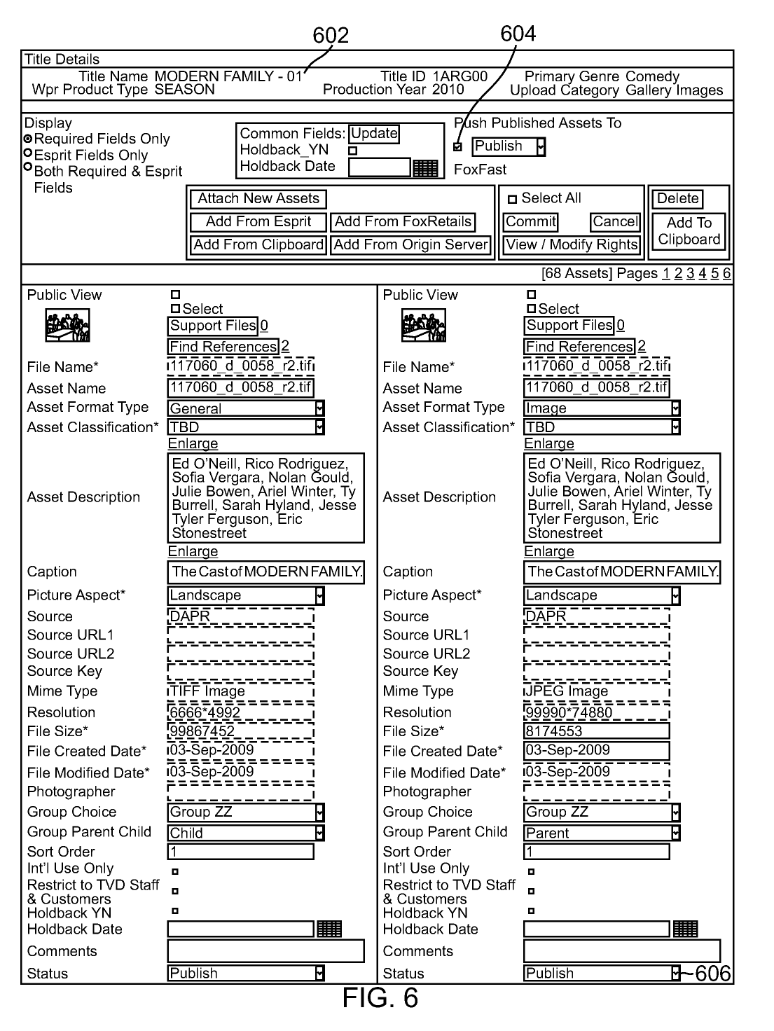

FIG. 5 illustrates a graphical user interface that provides menu access for uploading images that the user in FIG. 4 is authorized to perform (i.e., as a member of group 412). Once the user selects the “Load Images” menu option 502, further options are provided to load episodic photos, gallery images, title rep, logos and artwork, production stills, and event coverage.

FIG. 6 is a graphical user interface illustrating an example of images that have been uploaded for the media content “Modern Family” in accordance with one or more embodiments of the invention. The graphical user interface of FIG. 6 is presented to administrators that are uploading images and content for eventual use by customers 214. In FIG. 6, details for the title “Modern Family—01” 602 are illustrated. Checkbox 604 indicates that assets listed with a “Publish” status 606 are pushed to the FOXFAST™ system 212. Administrators (content uploaders) can specify details regarding the uploaded images such as the name of the file, the format type, a text description of the asset, a caption for the image, the aspect ratio (e.g., portrait/landscape), creation dates, etc.

In addition, in DAPR 210, administrators may desire to manage the content to enhance the search and viewing capabilities by customers 214. Accordingly, administrators may define keywords/categorizations for all available content (that can be searched by customers 214 when searching for content/assets).

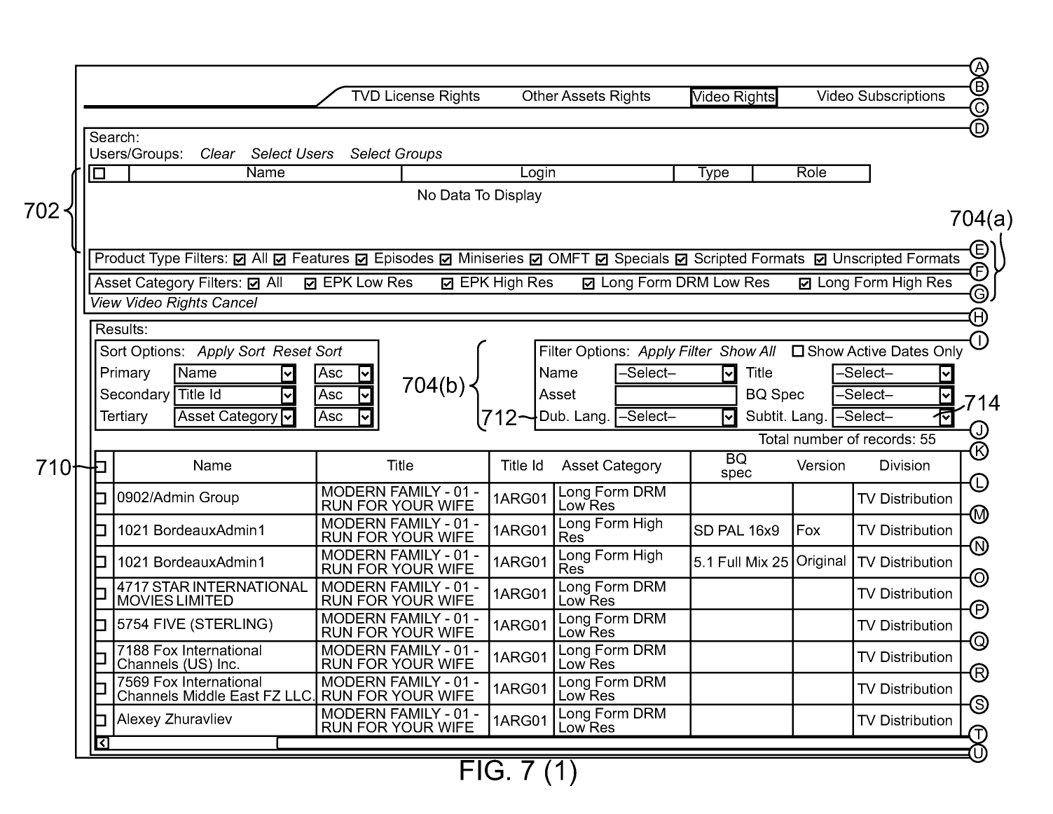

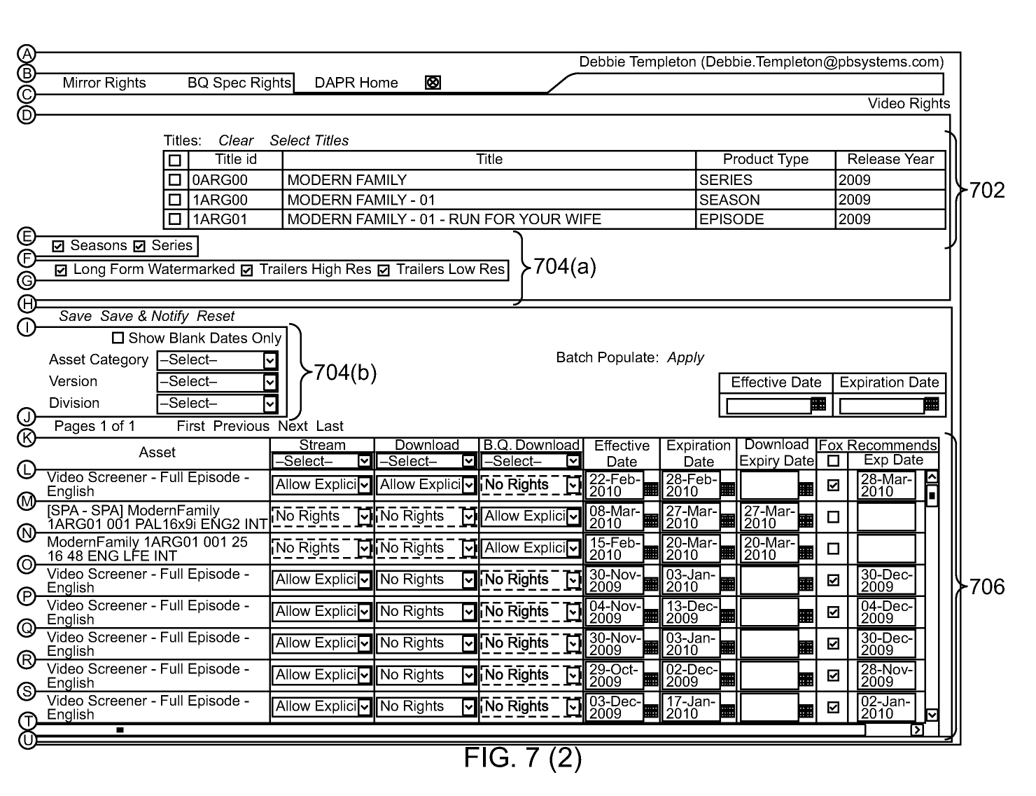

As part of content management, a video rights/security access screen may be displayed and provides the ability for administrators to manage access privileges by group/user. FIG. 7 is a graphical user interface used to define video rights/security access for groups/users in accordance with one or more embodiments of the invention. In the upper part of the graphical user interface, the administrator may select the video titles to manage. Accordingly, in area 702, the “Modern Family” series, 2009 season of “Modern Family,” and episode 01 of the first season have been selected (check boxes may be further used to filter the specific content from the video rights area). Further filters 704(a) and 704(b) may be used to limit the particular products and assets for which the administrator elects to define security privileges.

In one or more embodiments, in area 704(b), the administrator is provided with the capability to display assets based on an audio language selected (e.g., in field 712) or based on a subtitled language selected in field 714. Once such filter settings are specified in area 714, only foreign language versions will appear in grid 706. Further, each asset will be tagged with the appropriate audio/subtitle tag. For example, each of the assets identified in the “Asset” column of grid 706 include “English” or “ENG” to specify that the assets are in English and not foreign language versions.

The grid 706 provides the ability define the access privileges for the filtered products. Each row in the grid 706 represents a customer/group/user along with a particular title and format. In other words, if the grid 706 is viewed as a relational database table, the primary key for the grid 706 consists of the name of the customer/group/user+title of the media content+asset category (e.g., format) for the title. In this regard, the columns in grid 706 display the name of the customer/group/user, the title of the media content/video, the WPR (world product registry) title identifier, asset category (e.g., format for the title), the broadcast quality specification used for the title (“BQ Spec”), the version of the title (“version”), the division providing the title (e.g., television distribution), and a text description of the asset. Following each of the above columns are drop down boxes (or other types of input mechanisms) that allow the administrator to define access privileges for that row.

In FIG. 7, asset rights for the series title “Modern Family” are being defined. In the displayed example, the only users/groups retrieved are those that have an explicit right to the “Modern Family” series, season or episode 1 (e.g., as specified in area 702). Selecting only one or more titles and leaving the user/group area 708 unselected retrieves groups/users that have an explicit right to any of the assets for the titles/episodes selected in area 702.

By selecting a particular configuration in the header 710 of area 706, the administrator may assign a particular setting for the entire column (i.e., for all rows).

Within area 706, the “Stream” column provides the ability to explicitly set the access rights for online streaming the asset identified in the corresponding row. Options include “Allow Explicit,” “Allow Inherited,” or “No Rights.” For example, the streaming and downloading of low resolution assets may be set to “Allow Inherited” indicating inherited rights from the group's security settings. In one or more embodiments, the “Allow Inherited” setting may be set by the system via license rights (e.g., and not by a system administrator). Other options may also be available in embodiments of the invention. If the administrator utilizes the “Allow Explicit” setting, this area is used exclusively to define the rights for the corresponding customer/user/group and title/format (i.e., rather than relying on the settings set in the other graphical user interfaces described herein).

The “Download” column provides the ability to explicitly set download rights for downloading the corresponding asset in a non-broadcast quality format. The “BQ Download” column provides the ability to explicitly set rights for downloading broadcast quality (i.e., high resolution) versions of the corresponding row asset. It may be noted that the effective date and expiration date can be used to establish/define the time period within which the streaming/downloading/BQ downloading assets will be valid for the corresponding user/customer/group. By leaving such dates empty, the specified rights are set for perpetuity. The “Download Expiry Date” is used to define the last valid date for downloading broadcast quality or low resolution quality video. “Download Expiry Date” has to be less than or equal to asset expiration date for particular user. By default, the system will provide a thirty day window after the first download activity occurs for a particular asset. In other words, a user can download the same asset more than one time in that particular timing window only.

The “Fox Recommends” column provides the ability automatically push the specified content to a user/customer/group's video playlist “Spotlight” area until the expiration date entered. Such a video playlist and “Spotlight” will highlight particular assets that the administrator may feel are of particular interest to the customer (or which the administrator desires to promote). Video playlists are described in further detail in the co-pending application in the related applications section above.

Based on the above, the cells of grid 706 are used to define whether access is allowed, disallowed, etc., for particular types/formats of content. As an example, the first row of area 706 provides that the 0902/Admin Group has explicit streaming and download rights (but not broadcast quality rights) to a long form DRM low resolution video screener of the first episode of “Modern Family.” Similarly, the last displayed row of grid 706 provides that the user “Alexey Zhuravliev” as streaming but no download or broadcast quality download rights to a Long form DRM low resolution version of the first episode of “Modern Family.”

Embodiments of the invention may be fully integrated with the rights and sales contract management systems (i.e., systems 202-206) for automated asset access controls. License and contract terms from system 206 may be automatically reflected within the settings of DAPR (to control customer access to the data via system 212). Alternatively, such license and contract terms may be input directly into DAPR 212 to control user access to such assets in system 212.

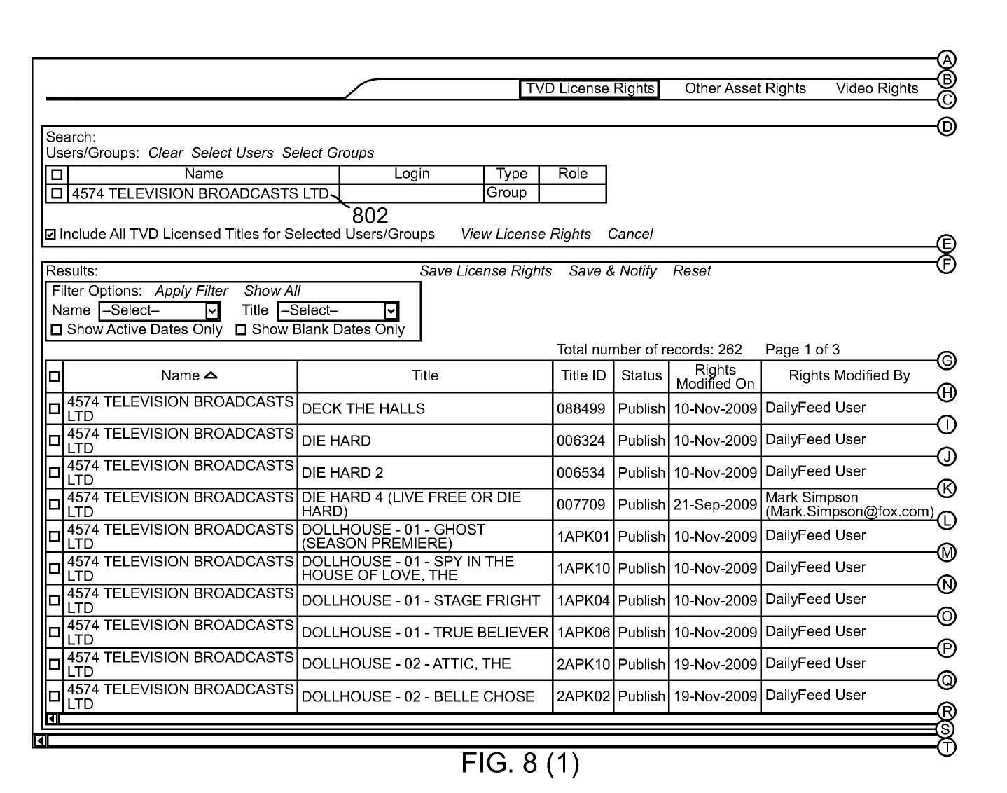

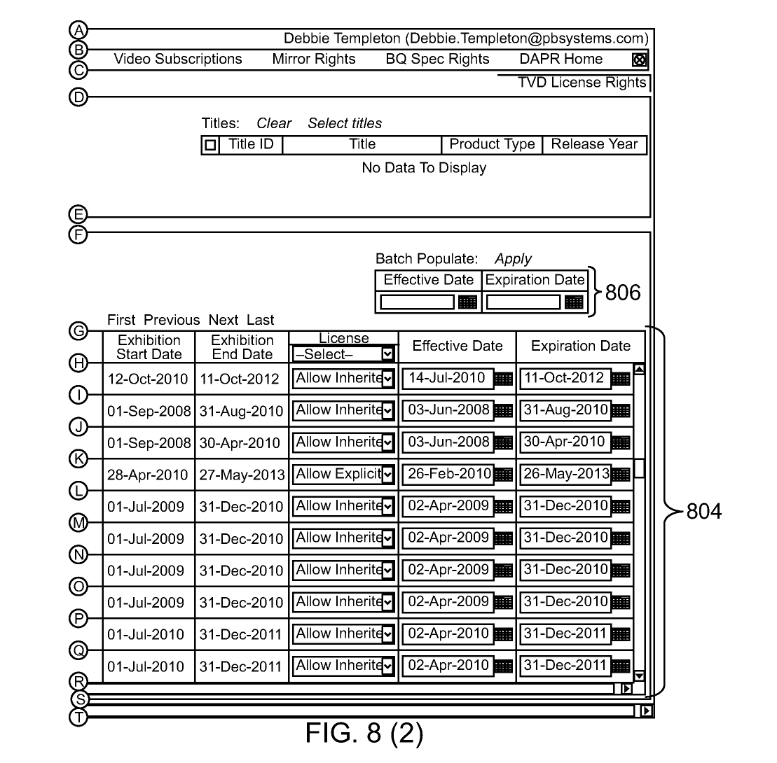

FIG. 8 is a graphical user interface illustrating a license rights option selected from an access management menu of DAPR 210 in accordance with one or more embodiments of the invention. As illustrated, an administrator is able to assign licensed rights for a customer (a.k.a. client) “4574 TELEVISION BROADASTS LTD” 802. Grid area 804 displays the explicit rights granted (rights dates entered from a different license rights screen [or automatically imported from a license/contract system 206]) for the non-series title “Die Hard 4” (as indicated by the “Allow Explicit” selection specified in the “License” column). While this particular entry has explicit rights, all other titles in grid 804 have inherited rights (as indicated by “Allow Inherited”). Accordingly, grid 804 also shows inherited rights granted (rights imported from contract system 206) for the series title “Dollhouse,” “Die Hard,” “Die Hard 2,” and “Deck the Halls.”

In FIG. 8, once the license has been specified, the effective and expiration dates may also be specified. Further, the effective and expiration dates can be set for all entries (e.g., as a batch) using fields 806.

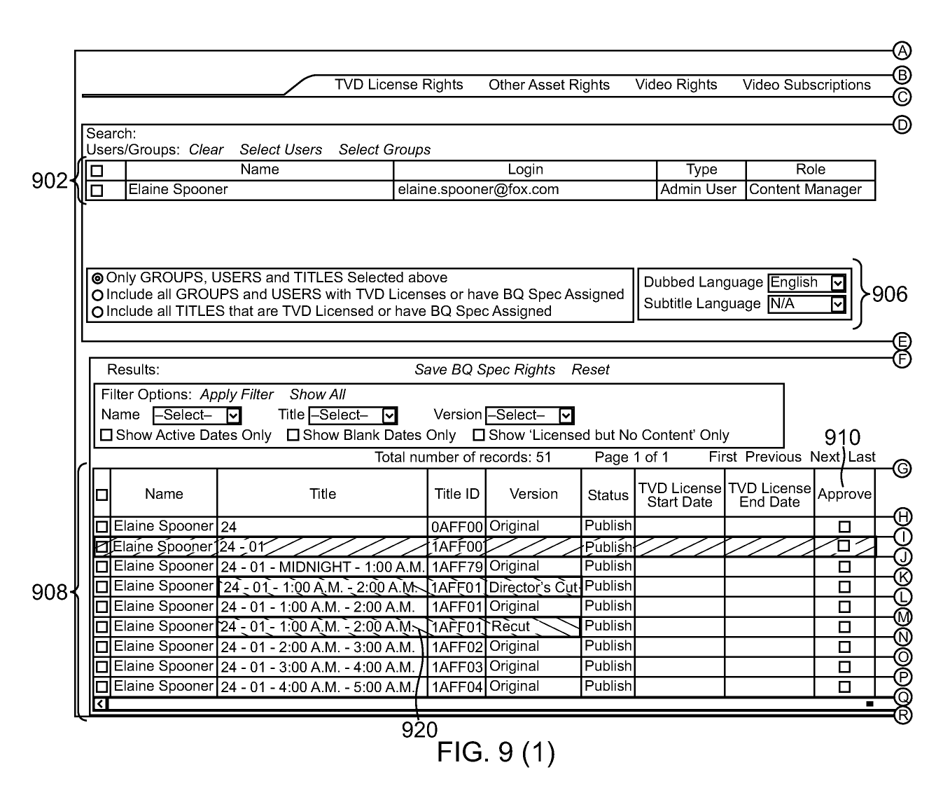

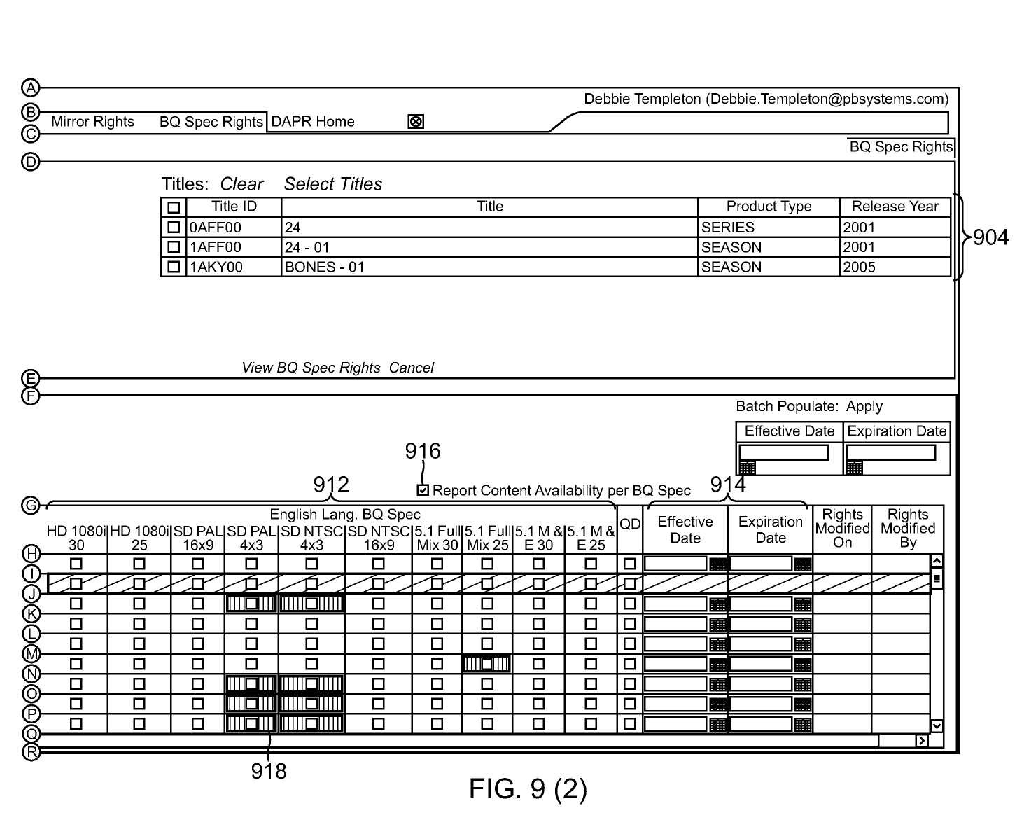

In addition to the above, broadcast quality content has a variety of formats for each title. While general authorizations may be defined as described above, additional parameters may be necessary to assign/select the authorizations for specific broadcast quality content that can be downloaded. FIG. 9 illustrates a graphical user interface used to assign broadcast quality rights for a season, series, or episode in accordance with one or more embodiments of the invention. Similar to FIGS. 7 and 8, area 902 is used to select the customer /group/user (e.g., “Elaine Spooner”), while area 904 may be used to select the titles (e.g., the “24” series, season 1 of “24”, and season 1 of “Bones”) for which the administrator desires to assign specific broadcast quality content authorizations. As described above, rights may be established for such authorization based on a group level or a user level to which the user belongs. Further, as described above, the greatest/least rights/authorizations across all groups/levels may be utilized. In this regard, an administrator may identify whether the great or least rights/authorizations should be prioritized.

The user can further select the particular dubbed language or subtitle language of the title desired using fields 906. In FIG. 9, the administrator has elected to use the English version of the “24” series, season 1 of “24”, and season 1 of “Bones” (as identified in areas 904 and 906).

Grid area 908 displays the titles and corresponding specific broadcast quality content selected. In this regard, all titles in the world product registry (WPR) may be shown, although not all titles may be available. Each row represents a different user/group/customer and corresponding title/version. In this regard, a season for a title would be displayed in a separate row from that of a series for that title. For non-series, each row is a separate title.

Within grid 908, the approve column 910 indicates whether approval for broadcast quality content has been authorized. Columns 912 provide the ability to select the specific broadcast quality content for the selected dubbed language. In FIG. 9, the selected dubbed language in field 906 is English. Accordingly, all of the specific broadcast quality contents are English language versions of the selected titles in 904 available to the selected customers 902. The different specific content 912 available in FIG. 9 includes HD 1080i 30 fps, HD 1080i 25 fps, SD PAL 16×9, SD PAL 4×3, SD NTSC 4×3, etc. The administrator can insert checkmarks in the relevant cells to indicate an authorization for the corresponding broadcast quality content download. Further, similar to FIG. 7, a single checkbox inserted at the top of each column (e.g., for an entire season if individual episodes are listed in separate rows), can be used to select the entire column and be used to preauthorize any episode that eventually may come online as part of a season for download by a user 902. In other words, the administrator can pre-authorize content before it is added to system 212 for delivery to users 902.

The effective date and expiration dates 914 allow the administrator to specify the period of time the broadcast quality content will be available for download to the customer 902 in system 212. In one or more embodiments the entry of dates in fields 914 may be required to authorize broadcast quality content downloads. It may be noted that any rights established in the graphical user interface of FIG. 9 will appear as inherited rights on the video rights graphical user interface of FIG. 7.

Field 916 provides the ability to report content availability per the broadcast quality specification. By checking the box 916, all content available for download by a client may be displayed in grid 908. Such items may be color coded or otherwise distinguishable. For example, a green background for a cell (illustrated as shaded cells 918) may indicate that such assets are currently available to the user 902. Those displayed without coloring (or in a different color such as red) may indicate not yet available. While a yellow background (illustrated as a different shade 920 in FIG. 9) may indicate licensed but coming soon. Such color coding informs the administrator what assets/titles may/may not be available now and in the near future so that the user can pre-authorize such assets if desired. Alternatively, the color coding may indicate whether an asset is available or not in the system at all.

In one or more embodiments, a notification system notifies users that content is ready for download or that title access is ready. For example, if an asset is color coded as not in the system but the user is pre-authorized for such an asset, once the asset is available in the system (e.g., ready/available for download), a notification such as an email, message, text message (e.g., software message service [SMS]), etc. may be transmitted to the user notifying the user of the asset's availability.

In view of FIGS. 7 and 9, one may note that the video rights table of FIG. 7 provides a more granular level of authorization and each file is identified in a separate row. However, in FIG. 9, the broadcast quality authorization graphical user interface allows for the selection of multiple files relating to a single broadcast quality title at a single time. For example, in a 5.1 surround sound system, each of the six files necessary for such content would appear on a separate row of FIG. 7. However, in FIG. 9, the column with the desired 5.1 surround system mix would merely be selected and would result in the authorization for all files associated with the selected mix.

### User Authentication for Broadcast Download Using Email Generated Token Verification

Broadcast quality video is often high resolution video that is highly desirable to those wishing to illegally exploit video/media content. Accordingly, increased security for such content is useful and often necessary. In addition, as employees of media content owners move to new places of employment, it is desirable to restrict such employee's access to the media content. To provide additional security for the broadcast quality video, embodiments of the invention provide for user authentication using email generated token verification.

When a user elects to download a broadcast quality item, an email containing a security token (also referred to as a token ID or token identification) is sent to the email address assigned to the user (e.g., using the user's email address with the place of employment). DAPR 210 (or administrators in the DAPR system 210) controls the email address assigned to the user. A dialog box is displayed to the user informing the user of the email with instructions to copy and paste the token from the email into the text box of the dialog box to complete the download process. An example of the email transmitted to the user provides:

Accordingly, the token is required to initiate the download process. Any attempt to avoid improper access by prior employees can therefore be thwarted because the prior employee will (hopefully) not have access to their prior email account with the prior employer and will not be able to retrieve the token.

In view of the above, it may be noted that token IDs are used as a verification to protect from unauthorized download requests by verifying the email address of the asset requestor. A single token ID may be provided per login session and a user may have the ability to reuse the same token ID to download multiple assets per login session. Alternatively, a new token ID may be generated per download request. In addition, a JAVA™ applet may be used to provide digital signatures to further enhance security.

### Content Protection and Security Overview

In view of the above, embodiments of the invention provide for broad capabilities for both assigning access rights (i.e., defining security protocols) to users and customers and also to ensuring such security protocols are adhered to. Further, different security protocols may be provided for preview video versus that of broadcast quality video due to the additional levels of security required for broadcast quality video. An overview of these security protocols is useful to better understand the invention.

Preview Video

Preview Video supplied via system/website 212 may be protected by MICROSOFT™'s WINDOWS MEDIA VERSION 10 DIGITAL RIGHTS MANAGEMENT (DRIVI)™ and allows licensees to stream, play and—in some cases—download selected video files. Preview Video may be available as follows:

Users must have WINDOWS MEDIA PLAYER VERSION 10™ or higher to play video files;

Preview Video for licensed product may be accessible during the terms of a license agreement; and

Preview Video for non-licensed product supplied for pre-sales/acquisitions use may be accessible for a period of no more than 90 days.

However, different DRM or non-DRM applications/protections and different/similar requirements/restrictions may be used in accordance with embodiments of the invention.

When a user attempts to stream a Preview Video file on system/website 212, the system, via embedded WINDOWS MEDIA PLAYER™ services, will determine if there is an existing license on the computer that permits the playing of video. If no license exists, the system/website 212 will manage a silent delivery request for a license to the user. If a user is authorized to receive such a license, a license will be delivered to the user's computer via WINDOWS MEDIA PLAYER™ services.

Embodiments of the invention may further utilize forensic digital watermarking (+DRM via WINDOWS MEDIA LICENSING SERVICES™). For highly sensitive Preview Video (i.e., theatrical films not yet released on DVD, non-aired television pilots, etc.), additional measures may be utilized to protect content. For any sensitive Preview Video content, specific grants to access material may be assigned as deemed necessary.

Sensitive Preview Video may be available for online streaming, but may include a unique, invisible session-based watermark that can be traced to an individual user. Before a watermarked video is streamed to a user, the user's e-mail address and a video file ID key may be stored on the server (or in DAPR 210). If a video file is shared, recorded from a PC screen by a video camera or otherwise leaked to another party in any way, only a few seconds of video footage is needed to trace the user who first received the video.

In addition to watermarks, a user must receive a WINDOWS MEDIA™ license for the streamed video to begin playing. System /website 212 may use the following WINDOWS MEDIA VERSION 10™ DRM licensing configuration for sensitive Preview Video:

WINDOWS MEDIA VERSION 10™ DRM (users may be required to have WINDOWS MEDIA PLAYER™ [version 10 or above], or a SILVERLIGHT™ player to play video files [e.g., WINDOWS MEDIA™ DRM content)

Duration of license: 24 hours (after 24 hours, a new license may be required to be acquired to again play/stream a particular Preview Video file)

Broadcast Video Security

Broadcast Video may be delivered using ASPERA™ or SIGNIANT™ file delivery solutions (or other solutions). Both of these third-party tools may accelerate, track, encrypt and manage the movement of content over public and private networks. Content is protected while it is in transit by scrambling and encoding information in a secure wrapper until it reaches its intended destination. Both solutions offer fast transfer speeds and strong encryption of at least AES-128 bit.

In addition to encryption, both file delivery solutions require password authentication for access and are seamlessly integrated with system/website 212. For Broadcast Video deliveries, a username and password is assigned to key broadcast material representatives only. The name of the assigned Broadcast Video representative can be confirmed with a licensee prior to assigning access. Representatives who are granted access to Broadcast Video files on behalf of a licensee may include the exclusive Broadcast Video representative for the licensee (i.e., access may be limited to Broadcast Video files to key users only).

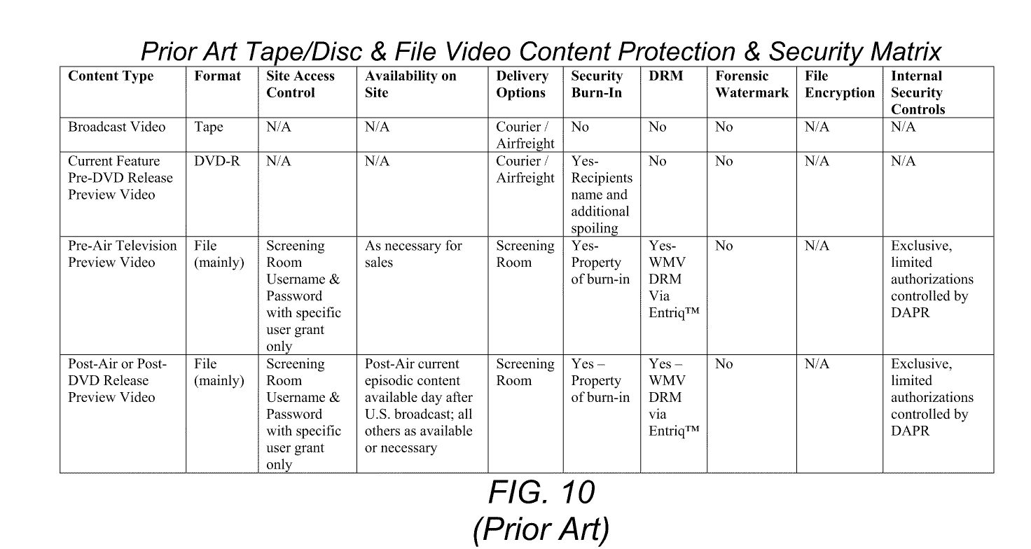

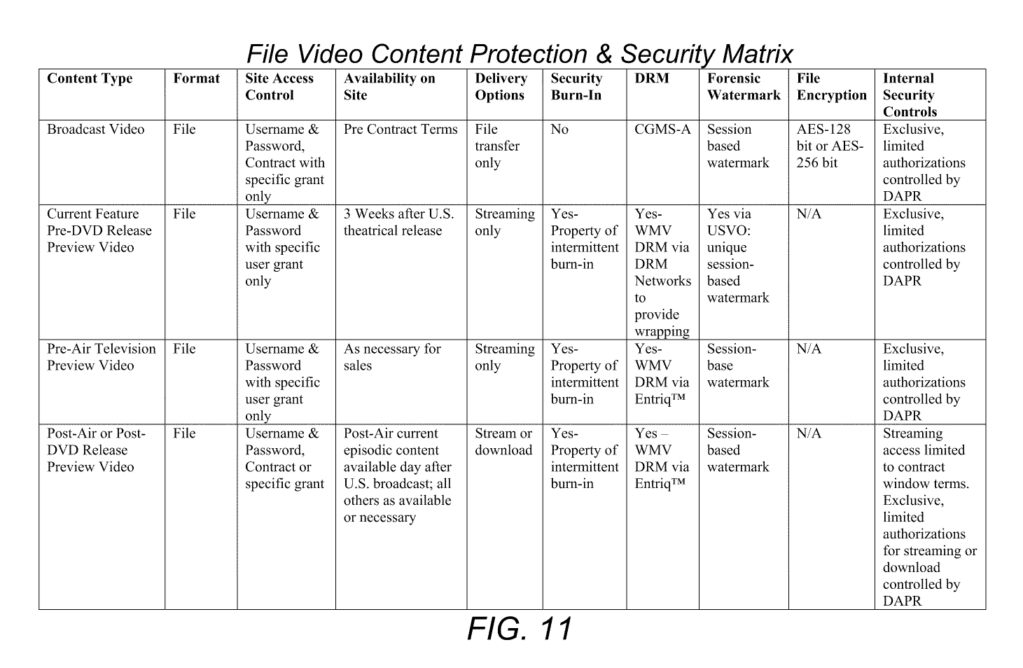

FIGS. 10 and 11 are tables illustrating a summary and comparison of the content protection used in the prior art (FIG. 10) and in accordance with embodiments of the invention (FIG. 11).

In addition to all the security measures mention above, DAPR 210 and system/website 212 may not support multiple browser logins for a particular user at the same time. In other words, a user may only have a single active session for DAPR 210 and system/website 212.

### Logical Flow

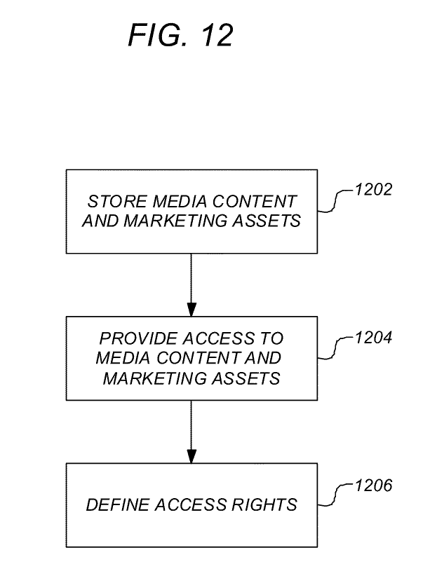

FIG. 12 is a flow chart illustrating the logical flow for delivering media content in a secure manner in accordance with one or more embodiments of the invention.

At step 1202, media content and marketing assets for the media content are stored in a repository.

At step 1204, access to the media content and marketing assets is provided via a website accessible on the Internet worldwide to a user.

At step 1206, an administrator defines, in a digital advertising publicity repository (DAPR), first access rights for the user to access the website and second access rights for the user to access the DAPR. As part of this step, the user may be assigned to one or more groups and the first access rights are assigned/defined on a group basis. The user inherits the first access rights assigned to the one or more groups to which the user is assigned. The second access rights may also enable the user to upload an image corresponding to a media title to the storage repository.

The first and second access rights may be defined using a grid. Each row in the grid represents a unique combination of: (a) a name of a user/group; (b) a title for media content; and (c) a format for the title. A first column allows the administrator to specify streaming access rights to stream the title in the format to the user/group. A second column allows the administrator to specify/define download access rights to download the title in the format to the user/group. A third column allows the administrator to specify broadcast quality download access rights to download, in broadcast quality, the title in the format to the user/group. The grid may also include fourth and fifth columns for specifying effective dates and expiration dates for the first three columns. A sixth column may be used to enable the administrator to have the title pushed to the user/group for display by the user/group on the website (e.g., to promote/spotlight the particular title to the user/group).

All of the access rights may be automatically inherited from a contract system that stores details regarding license terms of a contract/license between the user and owner of the media content.

As described above, additional (e.g., independent and explicit administrator) authorization may be required for a user to access broadcast quality media content. Such authorization may be provided using DAPR by utilizing a grid type table. Each row represents a unique combination of: (a) a name of a user/group; and (b) a title for media content. Broadcast quality columns are used to authorize broadcast quality content downloads, wherein each column is for a different broadcast quality format. The grid may further be filtered for a specific dubbed language for the title of the media content. In other words, only those users/groups and titles for broadcast quality formats available in the specified language to such customers are displayed in the grid structure. The grid may also be color-coded to indicate the current availability of the broadcast quality format for the user/group.

In addition, the access rights may further be defined using an email generated token verification. As part of such access rights, when a user requests broadcast quality download access, DAPR generates an email to a stored email address (for the user) that contains a token identification. The token identification is a unique user identification generated per login session of the user. The token identification is required to be entered by the user on the website prior to the user downloading (e.g., initiating the download for) the broadcast quality media content.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

In summary, embodiments of the invention and the use of digital and file-based content delivery systems may provide one or more of the following benefits.

Cost Savings and Productivity: licensees who accept file-based content delivery will benefit from digital delivery through the elimination of tape, shipping and physical media management costs while simultaneously increasing productivity.

Quality: Digital files may be maintained in broadcast quality video standards.

Convenience: all video assets will be accessible to licensees 24/7 subject to existing licensing arrangements.

Ease of Use: all video assets are well organized on a website for easy searching, locating and downloading.

Accessibility: multi-user access to filed-based video eliminates the need for internal tape copying and distribution.

Interoperability: files are compatible with both PCs and MACs.

Speed: point-to-point content distribution ensures files are delivered directly to where they need to be as soon as a file is accessed.

Storage: content is available using server-based storage allowing users to add flexibility to their own storage requirements.

Security: preview files are protected with digital rights management (DRM) software wrappers. Broadcast files are encrypted during transport and delivered via the internet. For some sensitive content, forensic watermarking may be applied. Additional forensic measures may also be used to guard the value of content against unauthorized use.

Digital Conversion: introduces licensees to file-based video formats and establishes an entry point for broadcasters to institutionalize digital workflows.

Eco-Friendly: Eliminates manufacturing, shipping and tape management infrastructure required to support physical deliveries thereby drastically reducing carbon emissions.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system for delivering media content in a secure manner in a computer system comprising:
(a) a storage repository configured to store media content and marketing assets for the media content;
(b) a server computer communicatively coupled to the storage repository and enabled to provide access to the media content and marketing assets via a website accessible on the Internet worldwide to a user;
(c) a digital advertising publicity repository (DAPR) configured to enable an administrator to define first access rights for the user to access the website and second access rights for the user to access the DAPR.

2. The system of claim 1, wherein:
the user is assigned to one or more groups;
the first access rights are assigned on a group basis; and
the user inherits the first access rights assigned to the one or more groups to which the user is assigned.

3. The system of claim 1, wherein the second access rights enable the user to upload an image corresponding to a media title to the storage repository.

4. The system of claim 1, wherein the first access rights and second asset rights are defined using a grid comprising:
(a) one or more rows with each row representing a unique combination of:
(i) a name of a user/group;
(ii) a title for media content; and
(iii) a format for the title;
(b) a first column for specifying streaming access rights to stream the title in the format for the title to the name of the user/group;
(c) a second column for specifying download access rights to download the title in the format for the title to the name of the user/group; and
(d) a third column for specifying broadcast quality download access rights to download, in broadcast quality, the title in the format for the title to the name of the user/group.

5. The system of claim 4, wherein the grid further comprises:
(e) a fourth column for specifying an effective date for the first column, the second column, and the third column; and
(f) a fifth column for specifying an expiration date for the first column, the second column, and the third column.

6. The system of claim 4, wherein the grid further comprises:
(g) a sixth column for specifying that the title is pushed to the name of the user/group for display by the user/group on the website.

7. The system of claim 1, wherein the first access right and the second access rights are automatically inherited from a contract system configured to store details regarding license terms of the user with an owner of the media content.

8. The system of claim 1, wherein a request from the user for access to broadcast quality media content requires independent explicit authorization from the administrator.

9. The system of claim 8, wherein the DAPR displays a grid to provide the explicit authorization, wherein the grid comprises:
(a) one or more rows with each row representing a unique combination of:
(i) a name of a user/group; and
(ii) a title for media content;
(b) one or more broadcast quality columns for authorizing broadcast quality content download, wherein each of the one or more broadcast quality columns comprises a different broadcast quality format.

10. The system of claim 9, wherein the grid is filtered for a specific dubbed language for the title of the media content.

11. The system of claim 9, wherein the grid is color-coded to indicate current availability of the broadcast quality format for the user/group.

12. A system for delivering media content in a secure manner in a computer system comprising:
(a) a server computer configured to receive a request, from a user, to download broadcast quality media content; and
(b) a digital advertising publicity repository (DAPR) that is configured to:
(i) control access to the broadcast quality media content; and
(ii) generate an email to a stored email address for the user,
wherein:
(1) the email comprises a token identification;
(2) the token identification comprises a unique user identification generated per login session of the user; and
(3) the token identification is required to be entered by the user prior to the user downloading the broadcast quality media content.

13. A system for delivering media content in a secure manner in a computer system comprising:
(a) a server computer configured to receive a request, from a user, to download broadcast quality media content;
(b) a digital advertising publicity repository (DAPR) communicatively coupled to the server computer, wherein the DAPR is configured to:
(i) control access to the broadcast quality media content; and
(ii) restrict download broadcast quality media content access, requested by the user to the server computer, to a specific internet protocol (IP) and/or media access control (MAC) address.

14. The system of claim 13, wherein the DAPR is further configured to accept input from an administrator that identifies the specific IP and/or MAC address information.

15. A computer implemented method for delivering media content in a secure manner, comprising:
(a) storing media content and marketing assets for the media content in a repository;
(b) providing access to the media content and marketing assets via a website accessible on the Internet worldwide to a user; and
(c) an administrator defining, in a digital advertising publicity repository (DAPR), first access rights for the user to access the website and second access rights for the user to access the DAPR.

16. The method of claim 15, further comprising assigning the user to one or more groups, wherein:
the first access rights are assigned on a group basis; and
the user inherits the first access rights assigned to the one or more groups to which the user is assigned.

17. The method of claim 15, wherein the second access rights enable the user to upload an image corresponding to a media title to the storage repository.

18. The method of claim 15, wherein the first access rights and second asset rights are defined using a grid comprising:
(a) one or more rows with each row representing a unique combination of:
(i) a name of a user/group;
(ii) a title for media content; and
(iii) a format for the title;
(b) a first column for specifying streaming access rights to stream the title in the format for the title to the name of the user/group;
(c) a second column for specifying download access rights to download the title in the format for the title to the name of the user/group; and
(d) a third column for specifying broadcast quality download access rights to download, in broadcast quality, the title in the format for the title to the name of the user/group.

19. The method of claim 18, wherein the grid further comprises:
(e) a fourth column for specifying an effective date for the first column, the second column, and the third column; and
(f) a fifth column for specifying an expiration date for the first column, the second column, and the third column.

20. The method of claim 18, wherein the grid further comprises:
(g) a sixth column for specifying that the title is pushed to the name of the user/group for display by the user/group on the website.

21. The method of claim 15, wherein the first access right and the second access rights are automatically inherited from a contract system configured to store details regarding license terms of the user with an owner of the media content.

22. The method of claim 15, wherein a request from the user for access to broadcast quality media content requires independent explicit authorization from the administrator.

23. The method of claim 22, further comprising the DAPR displaying a grid to provide the explicit authorization, wherein the grid comprises:
(a) one or more rows with each row representing a unique combination of:
(i) a name of a user/group; and
(ii) a title for media content;
(b) one or more broadcast quality columns for authorizing broadcast quality content download, wherein each of the one or more broadcast quality columns comprises a different broadcast quality format.

24. The method of claim 23, further comprising filtering the grid for a specific dubbed language for the title of the media content.

25. The method of claim 23, further comprising color-coding the grid to indicate current availability of the broadcast quality format for the user/group.

26. A computer implemented method for delivering media content in a secure manner, comprising:
(a) receiving a request, from a user, to download broadcast quality media content;
(b) generating an email to a stored email address for the user, wherein:
(i) the email comprises a token identification;
(ii) the token identification comprises a unique user identification generated per login session of the user; and
(iii) the token identification is required to be entered by the user on the website prior to the user downloading the broadcast quality media content;
(c) accepting entry of the token identification; and
(d) in response to a correct entry of the token identification, enabling the download of the broadcast quality media content to the user.

27. A computer implemented method for delivering media content in a secure manner, comprising:
(a) storing media content and marketing assets for the media content in a repository; and
(b) controlling access to the media content and marketing assets via a website accessible on the Internet worldwide to a user, wherein download broadcast quality media content access is restricted to a specific internet protocol (IP) and/or media access control (MAC) address.

28. The method of claim 27, further comprising an administrator defining, in a digital advertising publicity repository (DAPR), the specific IP and/or MAC address information.

29. A computer readable storage medium encoded with computer program instructions which when accessed by a computer cause the computer to load the program instructions to a memory therein creating a special purpose data structure causing the computer to operate as a specially programmed computer, executing a method of delivering media content in a secure manner, comprising:
(a) storing, in a repository, media content and marketing assets for the media content;
(b) providing, in the specially programmed computer, access to the media content and marketing assets via a website accessible on the Internet worldwide to a user; and
(c) an administrator defining, in a digital advertising publicity repository (DAPR), first access rights for the user to access the website and second access rights for the user to access the DAPR.

30. The computer readable storage medium of claim 29, further comprising assigning the user to one or more groups, wherein:
the first access rights are assigned on a group basis; and
the user inherits the first access rights assigned to the one or more groups to which the user is assigned.

31. The computer readable storage medium of claim 29, wherein the second access rights enable the user to upload an image corresponding to a media title to the storage repository.

32. The computer readable storage medium of claim 29, wherein the first access rights and second asset rights are defined using a grid comprising:
(a) one or more rows with each row representing a unique combination of:
(i) a name of a user/group;
(ii) a title for media content; and
(iii) a format for the title;
(b) a first column for specifying streaming access rights to stream the title in the format for the title to the name of the user/group;
(c) a second column for specifying download access rights to download the title in the format for the title to the name of the user/group; and
(d) a third column for specifying broadcast quality download access rights to download, in broadcast quality, the title in the format for the title to the name of the user/group.

33. The computer readable storage medium of claim 32, wherein the grid further comprises:
(e) a fourth column for specifying an effective date for the first column, the second column, and the third column; and
(f) a fifth column for specifying an expiration date for the first column, the second column, and the third column.

34. The computer readable storage medium of claim 32, wherein the grid further comprises:
(g) a sixth column for specifying that the title is pushed to the name of the user/group for display by the user/group on the website.

35. The computer readable storage medium of claim 29, wherein the first access right and the second access rights are automatically inherited from a contract system configured to store details regarding license terms of the user with an owner of the media content.

36. The computer readable storage medium of claim 29, wherein a request from the user for access to broadcast quality media content requires independent explicit authorization from the administrator.

37. The computer readable storage medium of claim 36, further comprising the DAPR displaying a grid to provide the explicit authorization, wherein the grid comprises:
(a) one or more rows with each row representing a unique combination of:
(i) a name of a user/group; and
(ii) a title for media content;
(b) one or more broadcast quality columns for authorizing broadcast quality content download, wherein each of the one or more broadcast quality columns comprises a different broadcast quality format.

38. The computer readable storage medium of claim 37, further comprising filtering the grid for a specific dubbed language for the title of the media content.

39. The computer readable storage medium of claim 37, further comprising color-coding the grid to indicate current availability of the broadcast quality format for the user/group.

40. A computer readable storage medium encoded with computer program instructions which when accessed by a computer cause the computer to load the program instructions to a memory therein creating a special purpose data structure causing the computer to operate as a specially programmed computer, executing a method of delivering media content in a secure manner, comprising:
(a) receiving a request, from a user, to download broadcast quality media content; and
(b) a digital advertising publicity repository (DAPR), generating an email to a stored email address for the user, wherein:
(i) the email comprises a token identification;
(ii) the token identification comprises a unique user identification generated per login session of the user; and
(iii) the token identification is required to be entered by the user prior to the user downloading the broadcast quality media content.

41. A computer readable storage medium encoded with computer program instructions which when accessed by a computer cause the computer to load the program instructions to a memory therein creating a special purpose data structure causing the computer to operate as a specially programmed computer, executing a method of delivering media content in a secure manner, comprising:
(a) storing media content and marketing assets for the media content in a repository; and
(b) controlling access to the media content and marketing assets via a website accessible on the Internet worldwide to a user, wherein download broadcast quality media content access is restricted to a specific internet protocol (IP) and/or media access control (MAC) address.

42. The computer readable storage medium of claim 41, further comprising an administrator defining, in a digital advertising publicity repository (DAPR), the specific IP and/or MAC address information.
